(19) United States
(12) Patent Application Publication
(10) Pub. No.: US 2024/0424329 A1
(43) Pub. Date: Dec. 26, 2024

(54) LIQUID FIRE SUPPRESSANT DEVICE

(71) Applicant: Carrier Corporation, Palm Beach Gardens, FL (US)

(72) Inventor: Aaron Foran, Gibsonville, NC (US)

(21) Appl. No.: 18/749,723

(22) Filed: Jun. 21, 2024

Related U.S. Application Data
(60) Provisional application No. 63/510,240, filed on Jun. 26, 2023.

(51) Int. Cl. A62C 13/64; B65D 83/54

(52) U.S. Cl. CPC A62C 13/64; B65D 83/54

(57) ABSTRACT

Described herein is a fire suppressant device. The device comprises a container configured to store a liquid fire suppressant agent having a predetermined gravity, and a propellant having a predetermined charge density, a valve assembly configured with the container, where the valve assembly comprises a stem valve comprising one or more first orifices having a combined tangential flow cross-sectional surface area of a first predetermined value, and a spray nozzle fluidically configured with the valve assembly, where the nozzle comprises one or more second orifices having a combined tangential flow cross-sectional surface area of a second predetermined value.

### CROSS-REFERENCE TO RELATED APPLICATION

This patent application claims the benefit of U.S. Provisional Patent Application No. 63/510,240, filed on Jun. 26, 2023, which is incorporated by reference herein in its entirety.

### BACKGROUND

Embodiments relate generally to fire suppression devices, and more particularly to portable fire suppression devices.

Kitchen fires in homes may often involve cooking fats and oils aflame in an open skillet on a range. Historically, portable fire extinguishers for fighting kitchen fires have used a dry chemical class BC fire suppressant such as sodium bicarbonate. The basic principle behind dry chemicals in extinguishing cooking fires is to combine the fatty esters in the cooking fat or oil with a metal alkali salt. While such dry chemical class BC fire suppressants have been effective for fighting cooking fires involving animal fats, some have exhibited reduced effectiveness when used in fighting fires involving lighter vegetable-based cooking oils.

As a result, a class of fire hazard was identified in view of the unique characteristics associated with such cooking oil fires. In fighting a cooking oil fire with a wet chemical fire extinguishing agent, the delivery of the wet chemical agent may not be so forceful as to substantially disturb the surface of the cooking oil, which may cause hot oil to be splashed out of the skillet and result in spreading of the fire to surrounding surfaces. Conventional portable fire extinguishers for kitchen fires may have drawbacks such as weight, size, ease of use, and ease of cleanup. Thus, alternate and safe solutions for extinguishing fires are needed.

### SUMMARY

Described herein is a fire suppressant device. The device comprises a container configured to store a liquid fire suppressant agent having a predetermined gravity, and a propellant having a predetermined charge density, a valve assembly configured with the container, where the valve assembly comprises a stem valve comprising one or more first orifices having a combined tangential flow cross-sectional surface area of a first predetermined value, and a spray nozzle fluidically configured with the valve assembly, the nozzle comprises one or more second orifices having a combined tangential flow cross-sectional surface area of a second predetermined value.

In one or more embodiments, the valve assembly, upon actuation of the nozzle, enables discharge of the fire suppressant agent at a predetermined flow rate and up to a predetermined discharge range through the one or more second orifices of the nozzle.

In one or more embodiments, the fire suppressant agent is selected based on a type of fire hazard to be suppressed by the device.

In one or more embodiments, the predetermined flow rate and the predetermined discharge range are selected based on the selected fire suppressant agent and/or a type of fire hazard to be suppressed.

In one or more embodiments, the combined tangential flow cross-sectional surface area of the first orifices and the combined tangential flow cross-sectional surface area of the second orifices are selected based on one or more of the selected fire suppressant agent, and the predetermined flow rate and the predetermined discharge range to be achieved.

In one or more embodiments, the selected predetermined discharge flow rate and the selected predetermined discharge range are determined based on one or more of the gravity of the fire suppressant agent, a charge density of the propellant, a charge ratio of the fire suppressant agent and the propellant within the container, the combined tangential flow cross-sectional surface area of the first orifices, and the combined tangential flow cross-sectional surface area of the second orifices, wherein the charge ratio is a ratio of a mass of the propellant and a mass of the fire suppressant agent stored in the container.

In one or more embodiments, the fire hazard is a UL711A or class A type of fire hazard.

In one or more embodiments, the device comprises a dip tube having a first end fluidically connected to the stem valve and a second end at least partially disposed in the liquid fire suppressant agent stored within the container.

In one or more embodiments, a tangential flow cross-sectional area of the dip tube is greater than the combined tangential flow cross-sectional surface area of the one or more first orifices.

In one or more embodiments, the second end of the dip tube has a non-linear profile to prevent blockage of the second end by an inner wall of the container.

In one or more embodiments, the valve assembly comprises a valve body hermetically sealed over an opening provided on the container, wherein the stem valve is accommodated and movably biased within the valve body using a spring, wherein a tangential flow cross-sectional area of the valve body is greater than the combined cross-sectional surface area of the one or more first orifices.

In one or more embodiments, the predetermined discharge range is between 4 feet to 7 feet.

In one or more embodiments, the predetermined flow rate is an effective discharge flow rate ranging between 0.53 oz/s (15 g/s) to 0.71 oz/s (20 g/s) or a volumetric discharge flow rate ranging between 0.42 fl. oz/s (18.1 mL/s) to 0.56 fl. oz/s (24.2 mL/s).

In one or more embodiments, the liquid fire suppressant agent has the predetermined gravity of 1.19 to 1.28.

In one or more embodiments, the liquid fire suppressant agent comprises an alkaline aqueous solution of a potassium salt selected from potassium acetate, or potassium bicarbonate.

In one or more embodiments, the propellant is an inert gas having the predetermined charge density ranging from 0.006 oz/fl. oz (0.006 g/mL) to 0.016 oz/fl. oz (0.015 g/mL).

In one or more embodiments, the propellant is an inert gas selected from nitrogen or carbon dioxide.

In one or more embodiments, the propellant is a liquid propellant having the predetermined charge density less than the liquid density of the fire suppressant, wherein the predetermined charge density is greater than or equal to 0.016 oz/fl. oz (0.015 g/mL).

In one or more embodiments, the combined tangential flow cross-sectional surface area of the one or more first orifices is greater than the combined tangential flow cross-sectional surface area of the one or more second orifices.

In one or more embodiments, the combined cross-sectional surface area of the one or more first orifices is 0.00450 in² to 0.00486 in², and the combined cross-sectional surface area of the one or more second orifices is 0.0012 in² to 0.0025 in²

In addition to the illustrative aspects, embodiments, and features described above, further aspects, embodiments, features, and techniques of the subject disclosure will become more apparent from the following description taken in conjunction with the drawings.

### BRIEF DESCRIPTION OF THE DRAWING

The accompanying drawings are included to provide a further understanding of the subject disclosure and are incorporated in and constitute a part of this specification. The drawings illustrate exemplary embodiments of the subject disclosure and, together with the description, serve to explain the principles of the subject disclosure.

In the drawings, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

These and other advantages and features will become more apparent from the following description taken in conjunction with the drawings.

FIGS. 1A and 1B illustrate an exemplary cross-section view of one or more embodiments of the fire suppressant device in accordance with one or more embodiments of the subject disclosure.

FIG. 2 illustrates an exemplary cross-section view of the valve assembly of the device in accordance with one or more embodiments of the subject disclosure.

FIG. 3A illustrates an exemplary view of an embodiment of the nozzle of the device of FIG. 1A in accordance with one or more embodiments of the subject disclosure. FIG. 3B illustrates an exemplary cross-section view of the nozzle of FIG. 3A.

FIG. 3C illustrates an exemplary view of another embodiment of the nozzle of the device of FIG. 1B in accordance with one or more embodiments of the subject disclosure.

FIGS. 4A and 4B illustrate exemplary views of the valve body associated with the valve assembly of FIG. 2 in accordance with one or more embodiments of the subject disclosure.

FIGS. 5A to 5C illustrate exemplary views of the stem associated with the valve assembly of FIG. 2 in accordance with one or more embodiments of the subject disclosure.

FIG. 6 illustrates an exemplary plot depicting discharge range and discharge flow rate for different diameters of second orifices in accordance with one or more embodiments of the subject disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the subject disclosure as defined by the appended claims.

Various terms are used herein. To the extent a term used in a claim is not defined below, it should be given the broadest definition persons in the pertinent art have given that term as reflected in printed publications and issued patents at the time of filing.

In the specification, reference may be made to the spatial relationships between various components and to the spatial orientation of various aspects of components as the devices are depicted in the attached drawings. However, as will be recognized by those skilled in the art after a complete reading of the subject disclosure, the components of this invention described herein may be positioned in any desired orientation. Thus, the use of terms such as “above,” “below,” “upper,” “lower,” “first”, “second” or other like terms to describe a spatial relationship between various components or to describe the spatial orientation of aspects of such components should be understood to describe a relative relationship between the components or a spatial orientation of aspects of such components, respectively, described herein may be oriented in any desired direction.

Conventional portable fire extinguishers may typically have a pressurized canister with a pull pin. The general public (not trained in firefighting) may not know how to use a conventional portable fire extinguisher or may experience difficulty using one, especially when confronted by an emergency situation. Additionally, the size and weight may present a use barrier for some people due to the strength required to use a conventional portable fire extinguisher. Further, conventional portable fire extinguishers may not be kept near pertinent locations for cooking oil fires such as a stove due to their size.

A liquid suppressant device may be used to safely and effectively extinguish Residential Class 711A or Class A type hazards that may arise in common household environments such as kitchen/grease, or linen fires. UL711A or Class A type fire hazard may be effectively extinguished with a liquid fire suppressant agent if the agent is delivered with a particular discharge flow character. However, while extinguishing a cooking oil fire or fighting UL711A or Class A type fire hazard with a liquid fire suppressant agent, the delivery of the fire suppressant agent may be forceful to substantially disturb the surface of the cooking oil, which may cause hot oil to be splashed out of the skillet and result in spreading of the fire to surrounding surfaces. Thus, there is a need to safely and effectively extinguish Residential Class 711A or Class A type hazards.

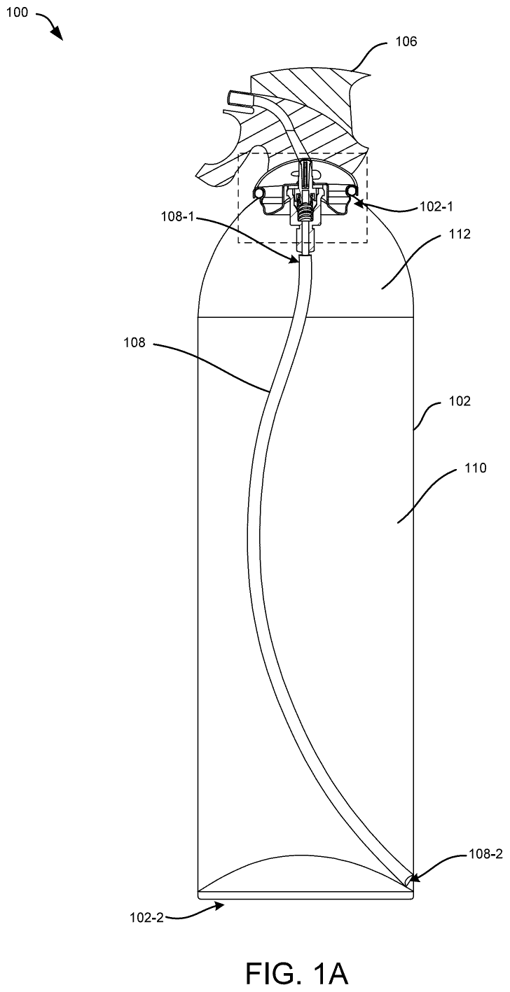

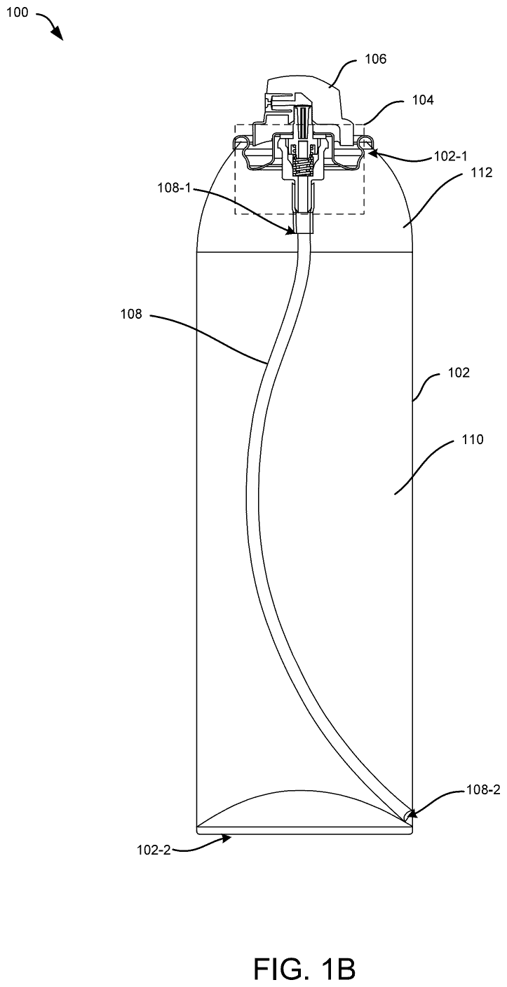

Referring to FIGS. 1A and 1B, a liquid-based fire suppressant device ‘device 100’ is disclosed. The device 100 may include a container 102 configured to store a liquid fire suppressant agent 110 (also referred to as suppressant or suppressant agent, herein), and a propellant 112 therein. In one or more embodiments, the container 102 may be a hollow cylindrical housing having a curved top end 102-1 with an opening, however, the container 102 and its top end 102-1 may also have other profiles without any limitations. The container 102 may be made of a corrosion-resistant, strong, and chemically inert material such as steel, aluminum and the like, which may store the liquid fire suppressant agent 110 and the propellant 112 therein without any leakage or degradation, and without affecting the chemical properties and pressure of the suppressant agent 110 and the propellant 112 within the container 102. Further, in one or more embodiments, the container 102 may be made of an electrically insulative material, or an exterior surface of the container 102 may be coated with an electrically insulative material to prevent any electric shock risk to users while using the device 100, specifically at the time of suppressant agent discharge when the discharged liquid fire suppressant agent 110 may come in contact with electrical equipment or electrical lines.

In addition, in one or more embodiments, the bottom base 102-2 of the container 102 may have a convex profile extending toward the interior of the container 102. The convex profile may help ensure that the device 100 remains stable when placed on a flat surface. Further, the convex profile, allows for volumetric expansion in the event of an over pressurization condition that may otherwise cause rupture improving the safety of the device.

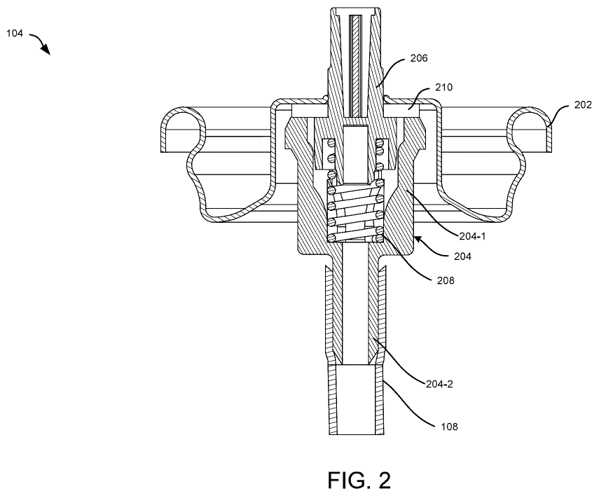

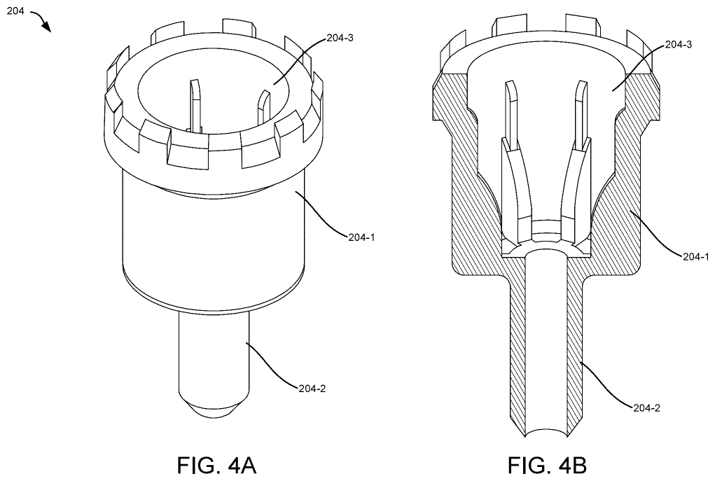

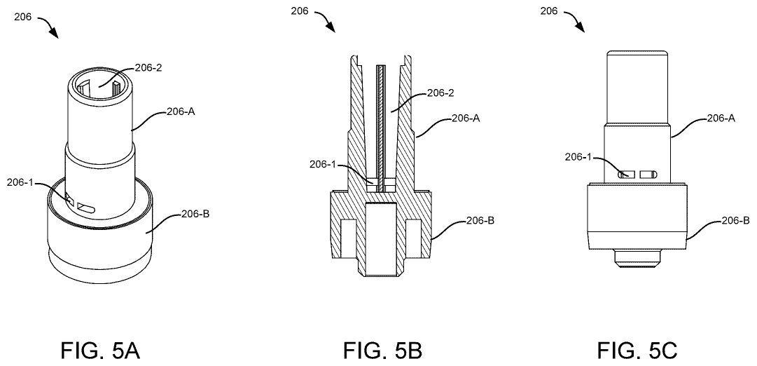

The device 100 may further include a valve assembly 104 configured at the opening (top end 102-1) of the container 102, where the valve assembly 104 may be configured to control the flow or discharge of the suppressant agent 110 and the propellant 112 from the container 102. Referring to FIGS. 1A to 5C, in one or more embodiments, the valve assembly 104 may include a valve cup 202 as shown in FIG. 2 that may be hermetically sealed or crimped over the opening provided on the container 102 as shown in FIGS. 1A and 1B, however, in some embodiments, the valve cup 202 may also be an integral part of the container 102. The valve assembly 104 may further include a valve body 204 as shown in FIG. 2 that may be hermetically sealed or disposed in the valve cup 202 using a gasket 210, such that the valve body 204 extends through an open section of the valve cup 202 or remains at least partially or fully within the container 102. The valve body 204 may include a hollow passage extending along its length and further having a seating area 204-3 at a top section 204-1 of the valve body 204 as shown in FIGS. 4A and 4B. Further, the valve assembly 104 may include a stem valve 206 movably disposed within the seating area of the valve body 204 and further biased within the seating area using a compression spring 208 as shown in FIG. 2. The stem valve 206 may include a hollow passage 206-2 extending along its length, and further including one or more first orifices 206-1 (also referred to as stem orifices 206-1, herein) fluidically connected to the hollow passage of the stem valve 206. Further, the stem valve 206 may be disposed within the seating area 204-3 of the valve body 204, such that the hollow passages of the valve body 204 and the stem valve 206 fluidically connect the first orifices 206-1 to an interior of the container 102, while at least an upper section 206-A of the stem valve 206 remains outside the container 102 or valve body 204 and a bottom section 206-B of the stem valve 206 remains within the container 102.

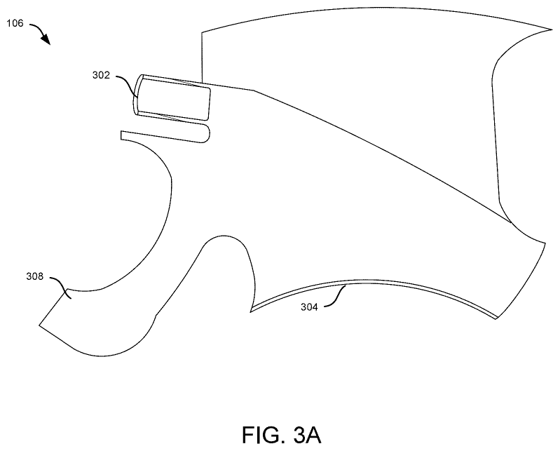

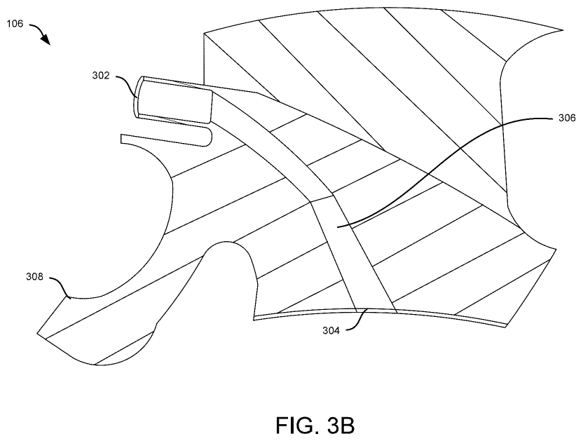

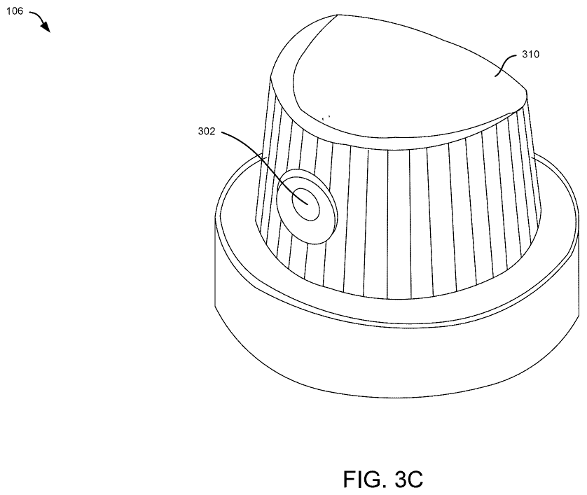

Referring to FIGS. 1A, 1B, and 3A to 3C, the device 100 may further include a spray nozzle 106 (also referred to as discharge actuator 106, herein) that may include a body comprising one or more second orifices 302 (also referred to as terminal orifices, herein) and inlet 304 connected by hollow passage(s) 306 as shown in FIGS. 3A to 3C. Additionally, in some embodiments, the nozzle 106 may include an air cap that may introduce air to assist in breaking up the liquid suppressant agent during discharge. The nozzle 106 may be configured on or with the valve assembly 104, such that inlet 304 of the nozzle 106 gets fluidically connected to the first orifices 206-1 of the stem valve 206.

Upon actuation of the nozzle 106, the second orifices 302 of the nozzle 106 may get fluidically connected to the first orifices 206-1 of the valve stem 206, causing the stored liquid suppressant agent to enter the nozzle 106 through the inlet 304 under pressure. As the liquid suppressant agent moves through the nozzle body, it may get pressurized and accelerate towards the second orifices 302, thereby forcing or discharging the liquid suppressant agent through the second orifices 302. In one or more embodiments, the nozzle 106 may be actuated by pressing knob 310 of the nozzle 106 as shown in FIG. 3C or by pressing a lever (handle) 308 associated with the nozzle 106 as shown in FIGS. 3A and 3B, which may push the stem valve 206 downwards against the spring 208 in the valve body 204, thereby fluidically connecting the second orifices 302 of the nozzle 106 to the first orifices 206-1 of the valve stem 206. Further, once the external force (pressing) is removed from the nozzle 106, the spring 208 may automatically move the valve stem 206 upwards, thereby fluidically disconnecting the second orifices 302 of the nozzle 106 and the first orifices 206-1 of the valve stem 206 to stop the discharge of suppressant agent and propellant from the device 100.

In addition, referring back to FIGS. 1A and 1B, the device 100 may include a dip tube 108 having a first end 108-1 fluidically connected to the bottom section (204-2 as shown in FIGS. 4A and 4B) of the valve body 204, and a second end 108-2 at least partially disposed in the liquid fire suppressant agent 110 stored within the container 102. In one or more embodiments, the second end 108-2 of the dip tube 108 may extend up to the bottom 102-2 of the container 102 and may have a non-linear profile to prevent blockage of the second end by the inner wall of the container 102. Accordingly, the valve assembly 104, upon actuation of nozzle 106, may enable the flow of the suppressant agent 110 from the interior of the container 102 towards the valve stem 206 and nozzle 106 via the dip tube 108, and further discharge the suppressant agent from the device 100 via the second orifices 302 of the nozzle 106.

In one or more embodiments, the discharge flow character of the liquid fire suppressant agent being discharged from the device 100 may be defined by a target ‘Discharge Range’ equal to the effective distance that the liquid suppressant agent may be delivered onto a high heat hazard without excessive evaporation and a ‘Discharge Flow-Rate’ which represents the mass of liquid suppressant agent delivered across the time domain of the discharge.

The discharge flow character may be defined by mathematical relationships between the gravity (or specific gravity or density) of the liquid fire suppressant agent and the charge density of the (vapor) propellant. The charge density of the propellant may be equal to the mass of the vapor divided by the pressure vessel headspace volume, where the pressure vessel headspace volume is the volume that remains above the liquid-vapor barrier within the container 102. Additionally, the ‘Charge Ratio’ also governs the discharge flow character of the liquid fire suppressant agent from the device 100. The Charge Ratio is the ratio of the mass of the propellant divided by the mass of the liquid fire suppressant agent.

In addition, the discharge flow character of the liquid fire suppressant agent is also defined by the profile and cross-sectional surface areas of the orifices 206-1, 302 associated with the stem valve 206 and the nozzle 106. The sum total of the combined cross-sectional surface areas of (n) number of first (stem valve) orifices 206-1 measured tangent to the direction of liquid flow, and a sum total of the combined cross-sectional surface areas of (n) number of second (terminal) orifices 302 measured tangent to the direction of liquid flow may define the performance of the device 100. Accordingly, the relationship between the combined surface areas of the orifices 206-1, 302, the charge density of the propellant, the specific gravity of the liquid fire suppressant agent, and the charge ratio may be specifically defined to deliver a predetermined discharge flow character (a predetermined flow rate and up to a predetermined discharge range) which may be determined to extinguish a specific fire hazard safely and effectively.

The discharge flow rate of the suppressant from the device may be equal to [ΣA+ΣB]×Charge Ratio, where ΣA is the sum total of the combined cross-sectional surface areas of (n) number of stem valve orifices measured tangent to the direction of liquid flow, ΣB is the sum total of the combined cross-sectional surface areas of (n) number of terminal orifices measured tangent to the direction of liquid flow, and Charge Ratio is ratio of the mass of the propellant divided by the mass of the liquid fire suppressant.

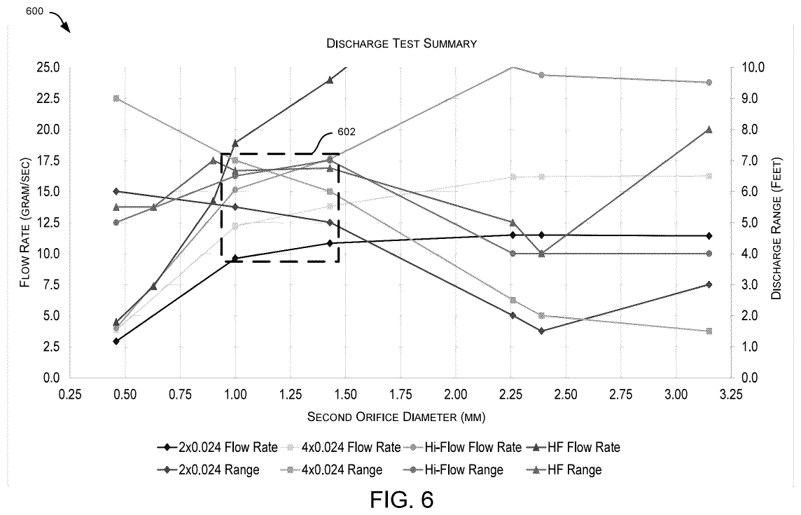

In one or more embodiments, the fire suppressant agent used in the device 100 may be selected based on a type of fire hazard to be suppressed by the device 100. Further, the predetermined flow rate and the predetermined discharge range may also be selected based on the selected fire suppressant agent and/or the type of fire hazard to be suppressed. Referring to FIG. 6, an exemplary plot depicting the discharge range and discharge flow rate for different diameters of second orifices 302 is disclosed. Accordingly, the combined tangential flow cross-sectional surface area of the first (stem valve) orifices 206-1 of the stem valve 206 and the combined tangential flow cross-sectional surface area of the second (terminal) orifices 302 of the nozzle 106 may be selected from the graph of FIG. 6, based on one or more of the material used as the fire suppressant agent, and the predetermined flow rate and the predetermined discharge range to be achieved to extinguish the specific fire hazard.

While various embodiments have been described herein for extinguishing UL711A or class A type fire hazards, however, the teachings of this invention may also be employed to extinguish other types of fire hazards, and all such embodiments are well within the scope of the subject disclosure without any limitations. In such embodiments, the material and the discharge flow character of the fire suppressant agent employed may be selected based on the type of fire hazard to be suppressed, and correspondingly the combined tangential flow cross-sectional surface area of the first (stem valve) orifices 206-1 of the stem valve 206 and the combined tangential flow cross-sectional surface area of the second (terminal) orifices 302 of the nozzle 106 may also be varied and selected.

In one or more embodiments, to extinguish a UL711A or class A type fire hazard, the device 100 may have the predetermined discharge range between 4 feet (1.2 meters) and 7 feet (2.1 meters). ‘Discharge range’ may be defined as the distance traveled by the liquid fire suppressant agent from the nozzle of the device 100 to a horizontal surface when the nozzle 106 of the device 100 is at a height of approximately 9.6 inches (245 mm) above the horizontal surface. Further, the device 100 may have an effective discharge flow rate between 0.53 oz/sec (15 gram/sec) and 0.71 oz/sec (20 gram/sec) measured as an average across the duration of the discharge time domain or a volumetric discharge flow rate between 0.42 fl. oz/s (18.1 mL/s) and 0.56 fl. oz/s (24.2 mL/s) measured as an average across the duration of the discharge time domain. However, it is to be appreciated that these numbers are exemplary and may be changed to a higher number or a lower number without any limitation whatsoever based on the fire hazard type, and all such implementations are well within the scope of the subject disclosure. Accordingly, referring to area 602 of FIG. 6, the diameter of the second orifice may be selected based on the predetermined discharge (ranging between 4 feet (1.2 meters) and 7 feet (2.1 meters)) and the predetermined effective discharge flow rate (ranging between 0.53 oz/s (15 g/s) to 0.71 oz/s (20 g/s)).

In one or more embodiments, to extinguish a UL711A or class A type fire hazard, the selected liquid fire suppressant agent may have a specific gravity of 1.19 to 1.28. In such embodiments, the liquid fire suppressant agent may comprise an alkaline aqueous solution of a potassium salt such as but not limited to potassium acetate, or potassium bicarbonate. In one or more embodiments, the propellant used in the device 100 may include inert gases such as but not limited to nitrogen, or carbon dioxide. In such embodiments, the liquid fire suppressant device 100 charged with inert gas may have a propellant charge density minimum of 0.006 oz/fl. oz (0.006 g/mL) and a propellant charge maximum of 0.016 oz/fl. oz (0.015 g/mL). Further, in other embodiments, the propellant used in the device 100 may be a liquid propellant or a blend of inert gas with liquid propellant such as but not limited to 1234ze. The liquid propellant may have a liquid density substantially less than the liquid density of the fire suppressant agent to minimize mixing. Furthermore, the minimum operable charge density for the device 100 when charged with liquid propellant may be 0.016 oz/fl. oz (0.015 g/mL). However, it is to be appreciated that the selected suppressant agent and propellant and these numbers are exemplary and may be changed without any limitation whatsoever based on the fire hazard type, and all such implementations are well within the scope of the subject disclosure.

In one or more embodiments, the combination of liquid fire suppressant agent and propellant used in the device 100 may be selected such that there is minimal or no chemical reaction possible between the liquid fire suppressant agent and propellant under the storage conditions of the device 100. For example, an aqueous solution of potassium acetate may not be used in combination with carbon dioxide as a propellant as it may result in the formation of a potassium bicarbonate salt which precipitates and may clog the delivery mechanism.

In one or more embodiments, based on the selected suppressant agent for extinguishing UL711A or class A type fire hazard, the sum total of the combined surface areas of (n) number of first (stem valve) orifices 206-1 may be 0.00180 in² to 0.00486 in², or 1.17 mm² to 3.14 mm². Further, the sum total of the combined surface areas of (n) number of the second (terminal) orifices 302 may be 0.0012 in² to 0.0025 in², or 0.77 mm² to 1.61 mm². As a result, the second (terminal) orifices 302 located on the nozzle 106 may form the discharge of the combined propellant and liquid fire suppressant agent. However, it is to be appreciated that these numbers are exemplary and may be changed to a higher number or a lower number without any limitation whatsoever based on the fire hazard and the selected fire suppressant agent, and all such implementations are well within the scope of the subject disclosure.

The device 100 may have a discharge duration greater than or equal to 25 seconds. However, the discharge duration may also be less than or equal to 30 seconds. ‘Discharge duration’ is defined as the amount of time required to discharge the liquid fire suppressant composition from the device 100 when the device trigger is fully and continually depressed. Discharge Duration is considered complete at a discharge gas point, where ‘Discharge gas point’ is defined as the point in time when the discharge composition changes from the extinguishing agent alone to a gas and extinguishing agent combination.

In one or more embodiments, the device 100 may store a predefined volume of the fire suppressant composition that may be greater than or equal to 14 fluid ounces (fl. oz) and may have a maximum flow rate less than or equal to 20 grams per second (g/sec). However, it is to be appreciated that these numbers are exemplary and may be changed to a higher number or a lower number without any limitation whatsoever based on the discharge duration to be achieved while maintaining the predetermined discharge range and flow rate, and all such implementations are well within the scope of the subject disclosure.

Thus, this invention provides a compact, portable, and easily stowable liquid suppressant-based fire suppressant device that is capable of safely and effectively extinguishing Residential Class 711A or Class A type hazards, and which also provides an intuitive and familiar functional form to the average residential consumer. Additionally, the use of a liquid suppressant in the device provides for an easy clean-up and more concentrated delivery system 206 than a traditional powder extinguisher.

While the invention has been described in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description but is only limited by the scope of the appended claims.

1. A fire suppressant device comprising:
a container configured to store a liquid fire suppressant agent having a predetermined gravity, and a propellant having a predetermined charge density;
a valve assembly configured with the container, the valve assembly comprises a stem valve comprising one or more first orifices having a combined tangential flow cross-sectional surface area of a first predetermined value; and
a spray nozzle fluidically configured with the valve assembly, the nozzle comprises one or more second orifices having a combined tangential flow cross-sectional surface area of a second predetermined value.

2. The device of claim 1, wherein the valve assembly, upon actuation of the nozzle, enables discharge of the fire suppressant agent at a predetermined flow rate and up to a predetermined discharge range through the one or more second orifices of the nozzle.

3. The device of claim 2, wherein the fire suppressant agent is selected based on a type of fire hazard to be suppressed by the device.

4. The device of claim 2, wherein the predetermined flow rate and the predetermined discharge range are selected based on the selected fire suppressant agent and/or a type of fire hazard to be suppressed.

5. The device of claim 3, wherein the combined tangential flow cross-sectional surface area of the first orifices and the combined tangential flow cross-sectional surface area of the second orifices are selected based on one or more of the selected fire suppressant agent, and the predetermined flow rate and the predetermined discharge range to be achieved.

6. The device of claim 2, wherein the selected predetermined discharge flow rate and the selected predetermined discharge range are determined based on one or more of gravity of the fire suppressant agent, a charge density of the propellant, a charge ratio of the fire suppressant agent and the propellant within the container, the combined tangential flow cross-sectional surface area of the first orifices, and the combined tangential flow cross-sectional surface area of the second orifices, wherein the charge ratio is a ratio of a mass of the propellant and a mass of the fire suppressant agent stored in the container.

7. The device of claim 3, wherein the fire hazard is a UL711A or class A type fire hazard.

8. The device of claim 1, wherein the device comprises a dip tube having a first end fluidically connected to the stem valve and a second end at least partially disposed in the liquid fire suppressant agent stored within the container.

9. The device of claim 8, wherein a tangential flow cross-sectional area of the dip tube is greater than the combined tangential flow cross-sectional surface area of the one or more first orifices.

10. The device of claim 8, wherein the second end of the dip tube has a non-linear profile to prevent blockage of the second end by an inner wall of the container.

11. The device of claim 1, wherein the valve assembly comprises a valve body hermetically sealed over an opening provided on the container, wherein the stem valve is accommodated and movably biased within the valve body using a spring, wherein a tangential flow cross-sectional area of the valve body is greater than the combined cross-sectional surface area of the one or more first orifices.

12. The device of claim 2, wherein the predetermined discharge range is between 4 feet to 7 feet.

13. The device of claim 2, wherein the predetermined flow rate is an effective discharge flow rate ranging between 0.53 oz/s (15 g/s) to 0.71 oz/s (20 g/s) or a volumetric discharge flow rate ranging between 0.42 fl. oz/s (18.1 mL/s) to 0.56 fl. oz/s (24.2 mL/s).

14. The device of claim 1, wherein the liquid fire suppressant agent comprises an alkaline aqueous solution of a potassium salt selected from potassium acetate, or potassium bicarbonate.

15. The device of claim 1, wherein the propellant is an inert gas having the predetermined charge density ranging from 0.006 oz/fl. oz (0.006 g/mL) to 0.016 oz/fl. oz (0.015 g/mL).

16. The device of claim 1, wherein the propellant is an inert gas selected from nitrogen, or carbon dioxide.

17. The device of claim 1, wherein the propellant is a liquid propellant having the predetermined charge density less than the liquid density of the fire suppressant, wherein the predetermined charge density is greater than or equal to 0.016 oz/fl. oz (0.015 g/mL).

18. The device of claim 1, wherein the combined tangential flow cross-sectional surface area of the one or more first orifices is greater than the combined tangential flow cross-sectional surface area of the one or more second orifices.

19. The device of claim 1, wherein the combined cross-sectional surface area of the one or more first orifices is 0.00450 in² to 0.00486 in², and the combined cross-sectional surface area of the one or more second orifices is 0.0012 in² to 0.0025 in².
